(19) United States
(12) Patent Application Publication
(10) Pub. No.: US 2009/0249388 A1
(43) Pub. Date: Oct. 1, 2009

(54) Confirmation of Advertisement Viewing

(75) Inventors: Joseph J. Seidel, Menlo Park, CA (US); Nadav M. Neufeld, Sunnyvale, CA (US); Pradhan S. Rao, Sunnyvale, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/060,839

(22) Filed: Apr. 1, 2008

(51) Int. Cl. H04N 7/10

(52) U.S. Cl. 725/32

(57) ABSTRACT

Techniques to confirm advertisement viewing are described. In an implementation, an advertisement is displayed on a remote control device having functionality to initiate one or more control functions to control a display of content by a client. A user is confirmed to have viewed an advertisement output by the client through interaction with the advertisement displayed on the remote control device.

### BACKGROUND

Advertising continues to be a significant source of revenue to content providers and distributors even though the ways in which users may consume content continues to expand. For example, users were previously limited to traditional over-the-air broadcasts of television programming that were consumed as the television programming was broadcast. “Time shifting” techniques were subsequently developed in which users could store the television program for output when desired, e.g., using a digital video recorder (DVR). The time shifting techniques, however, led to a perceived loss of value for the advertisements because users could use the time shifting techniques to skip output of the advertisements, e.g., by fast forwarding. This has created at least two problems: first a perception that people are not watching advertising when they have DVRs, even though they still may be (e.g., users may still view a significant portion of advertisements in live television programming, especially sporting events); and second, the reality that people may not be watching advertisements as much as they had before the advent of DVRs. Both of these problems may result in lost revenue for content providers and distributors, such as network operators.

### SUMMARY

Techniques to confirm advertisement viewing are described. In an implementation, an advertisement is displayed on a remote control device. The remote control device has functionality to initiate one or more control functions to control a display of content by a client. A user is confirmed to have viewed an advertisement output by the client through interaction with the advertisement displayed on the remote control device.

In another implementation, a service is provided to display advertisements on a remote control device that is configured to initiate one or more control functions related to output of content by a client. Revenue is collected from one or more advertisers that provide respective advertisements based on confirmed interaction with the advertisements.

In a further implementation, one or more computer-readable media include instructions that are executable to determine a number of times an advertisement has been selected when displayed on one or more remote control devices. The one or more remote control devices are each configured to initiate one or more control functions related to an output of content by a respective client. The instructions are further executable to calculate a fee to be charged to an advertiser that provided the advertisement based at least in part on the determined number of times the advertisement was selected.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques to confirm advertisement viewing using a remote control device.

FIG. 2 is an illustration of an example system showing the remote control device of FIG. 1 in greater detail as displaying representations of one or more control functions of a client of FIG. 1 that may be initiated through selection on the remote control device when in a control function mode.

FIG. 3 is an illustration of an example system showing the remote control device of FIG. 2 as displaying an advertisement.

FIG. 4 is an illustration of an example system showing the remote control device of FIG. 2 as displaying an advertisement that includes a query that requests confirmation of viewing of the advertisement output by the client.

FIG. 5 is an illustration of an example system showing the remote control device of FIG. 2 as displaying an advertisement that includes an incentive to confirm viewing of an advertisement.

FIG. 6 is a flow diagram depicting a procedure in an example implementation in which viewing of an advertisement is confirmed.

FIG. 7 is a flow diagram depicting a procedure in an example implementation in which a business model is supported through confirmation of advertisement viewing.

### DETAILED DESCRIPTION

Overview

There is a perceived loss in advertising value by some advertisers due to the ever expanding ways in which users may consume content. For example, “time shifting” techniques enable users to store a television program for output when desired, e.g., using a digital video recorder (DVR). However, the time shifting techniques may also be used to skip output of the advertisements. Therefore, because it was traditionally unknown as to whether users watched advertisements in a television program, the perception that users might not have watched the advertisements (whether right or wrong) resulted in lost revenue to content providers and distributors.

Techniques are described to confirm advertisement viewing. In an implementation, a remote control device includes a display device that is used to output advertisements. For example, the remote control device may be configured as a “glassy brick” that includes a touch screen that covers at least approximately half (e.g., more than forty percent) of an outer surface of the remote control device.

The display device of the remote control device, for instance, may be implemented such that representations of control functions and other data are reconfigurable and therefore may be displayed on the remote control device 106 in a variety of ways. For example, different portions of the display device of the remote control device 106 may be configured to detect contact and/or proximity of an object to the display device such that different portions of the display device are selectable. A variety of different techniques may be used to detect selection, such as through resistive techniques, surface acoustic waves, capacitive, infrared, use of strain gauges, optical imaging, dispersive signal technology, acoustic pulse recognition, frustrated total internal reflection, and so on. Using these techniques, a variety of data may be displayed on the display device of the remote control device. Further, interaction with the displayed data may be performed in a variety of ways.

For example, the display device of the remote control device may be leveraged to provide a wide variety of functionality, such as to output a variety of advertisements. For example, advertisements on the remote control device may be coordinated with advertisements or other content output on a client, e.g., a television. An advertisement displayed on the remote control device, for example, may be a logo of a brand that corresponds to an advertisement output by the client. In another example, the advertisement output on the remote control device is selected based on what content is currently being output by the client (e.g., by “knowing” what is being output by the client), such as to coordinate a golf club advertisement output on the remote control device with a golf television program. In this way, the remote control device may be leveraged to provide advertisements to a user in an unobtrusive way such that content output by the client is not disrupted. In addition, these advertisements are more valuable to the advertisers because they can be more targeted to a user.

The advertisements displayed on the remote control device may also be used to confirm that a user has viewed an advertisement on the client and even on the remote control device itself. For example, an advertisement may be displayed on a television and an advertisement may also be displayed on the remote control device. The advertisement displayed on the remote control device may include an incentive, e.g., a display of a coupon for ten percent off a next purchase of dog food. When the user selects the advertisement, the incentive may be made available to the user, e.g., through download, email, simple message service (SMS), and so on. Selection of the advertisement may also be used confirm that the user has watched the advertisement on the client and/or the advertisement that was displayed by the remote control device. Thus, advertisers may be given an accurate account of how many “impressions” have occurred of a particular advertisement. This confirmation may then be used as a basis for collecting revenue from the advertiser, such as a fee for each confirmed viewing of an advertisement, further discussion of which may be found in relation to the following figures.

In the following discussion, an example environment is first described that is operable to perform techniques to confirm viewing of advertisements using a remote control device. Example procedures are then described that may be employed in the example environment, as well as in other environments. Although the confirmation techniques in the following discussion relate to a television environment, it should be readily apparent that a wide variety of contexts may leverage these techniques without departing from the spirit and scope thereof, such as through use of wireless phones that are usable to control content of other clients such as vending machines and so on.

Example Environment

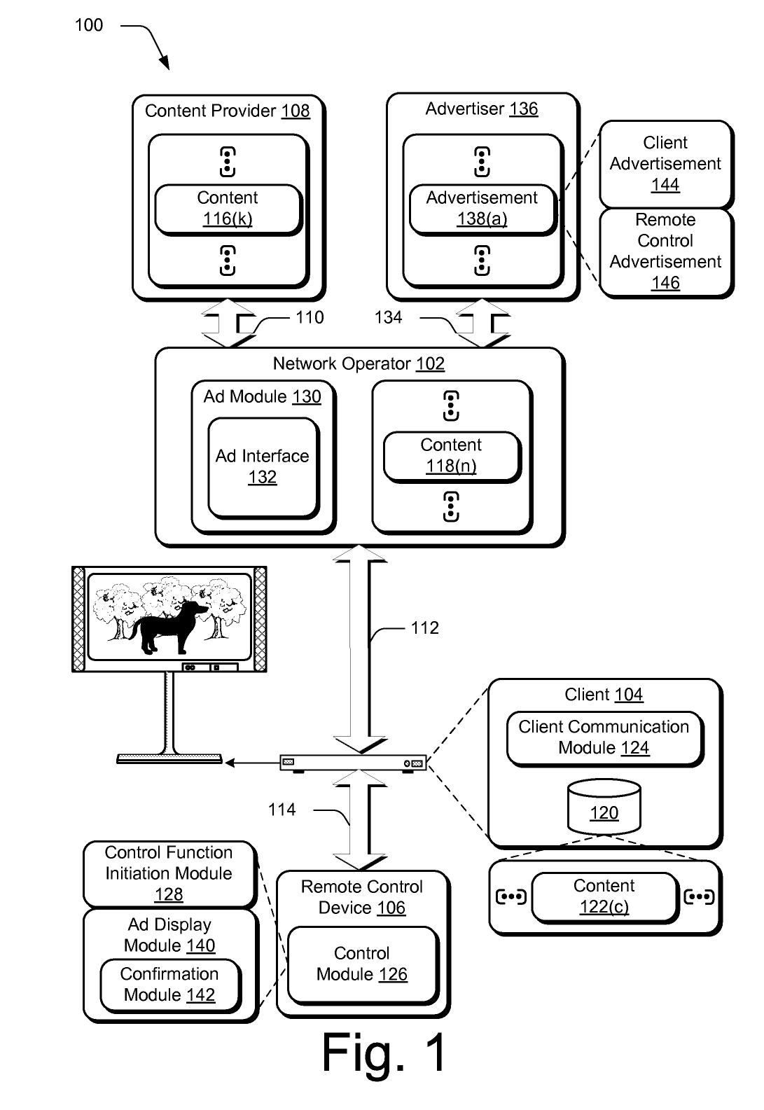

FIG. 1 is an illustration of an environment 100 in an example implementation that is operable to employ techniques to confirm advertisement viewing. The illustrated environment 100 includes a network operator 102 (e.g., a “head end”), a client 104, a remote control device 106 and a content provider 108 that are communicatively coupled, one to another, via network connections 110, 112, 114. In the following discussion, the network operator 102, the client 104, the remote control device 106 and the content provider 108 may be representative of one or more entities, and therefore by convention reference may be made to a single entity (e.g., the client 104) or multiple entities (e.g., the clients 104, the plurality of clients 104, and so on).

Additionally, although a plurality of network connections 110-114 are shown separately, the network connections 110-114 may be representative of network connections achieved using a single network or multiple networks. For example, network connections 110, 112 may be implemented via the internet or other packet-switched network and network connection 114 may be implemented via a local network connection, such as via infra red, a radio frequency connection, and so on. In another example, network connection 114 may also be implemented via the internet.

The client 104 may be configured in a variety of ways. For example, the client 104 may be configured to be capable of communicating over the network connections 112, 114, such as a television, a mobile station, an entertainment appliance (e.g., a game console), a set-top box communicatively coupled to a display device as illustrated, a wireless phone, and so forth. Thus, the client 104 may range from a full resource device with substantial memory and processor resources (e.g., television-enabled personal computers, television recorders equipped with hard disk) to a low-resource device with limited memory and/or processing resources (e.g., traditional set-top boxes).

Communication of content to the client 104 may be performed in a variety of ways. For example, the client 104 may be communicatively coupled to the content provider 108 (which may be representative of one or more content providers) using a packet-switched network, e.g., the Internet. Accordingly, the client 104 may receive one or more items of content 116(k), where “k” can be any integer from 1 to “K” directly from the content provider 108, e.g., via one or more websites. The content 116(k) may include a variety of data, such as television programming, video-on-demand (VOD) files, one or more results of remote application processing, and so on. A variety of other examples are also contemplated, such as by using an indirect distribution example in which the content 116(k) is communicated over the network connection 110 to the network operator 102.

Content 116(k), as illustrated in the example environment 100 of FIG. 1, is communicated via the network connection 110 is received by the network operator 102 and may be stored as one or more items of content 118(n), where “n” can be any integer from “1” to “N”. The content 118(n) may be the same as or different from the content 116(k) received from the content provider 108. The content 118(n), for instance, may include additional data for broadcast to the client 104. For example, the content 118(n) may include electronic program guide (EPG) data from an EPG database for broadcast to the client 104 utilizing a carousel file system and an out-of-band (OOB) channel. Distribution from the network operator 102 to the client 104 over network connection 112 may be accommodated in a number of ways, including cable, radio frequency (RF), microwave, digital subscriber line (DSL), and satellite.

The client 104, as previously stated, may be configured in a variety of ways to receive the content 118(n) over the network connection 114. The client 104 typically includes hardware and software to transport and decrypt content 118(n) received from the network operator 102 for output to and rendering by the illustrated display device. Although a display device is shown, a variety of other output devices are also contemplated, such as speakers. Although the display device is illustrated separately from the client 104, it should be readily apparent that the client 104 may also include the display device as an integral part thereof, e.g., as a traditional television as previously described.

The client 104 may also include digital video recorder (DVR) functionality. For instance, the client 104 may include a storage device 120 to record content 118(n) as content 122(c) (where “c” can be any integer from one to “C”) received via the network connection 112 for output to and rendering by the display device. The storage device 120 may be configured in a variety of ways, such as a hard disk drive, a removable computer-readable medium, and so on. Thus, content 122(c) that is stored in the storage device 120 of the client 104 may be copies of the content 118(n) that was streamed from the network operator 102. Additionally, content 122(c) may be obtained from a variety of other sources, such as from a removable computer-readable medium that is accessed by the client 104, and so on. For example, content 122(c) may be stored on a digital video disc (DVD) when the client 104 is configured to include DVD functionality.

The illustrated client 104 includes a client communication module 124 that is representative of functionality of the client 104 to control content interaction on the client 104, such as through the use of one or more “control functions”. The control functions may include a variety of functions to control output of content, such as to control volume, change channels, select different inputs, configure surround sound, and so on. The control functions may also one or more “trick modes” to provide non-linear playback of the content 122(c) (i.e., time shift the playback of the content 122(c)) such as pause, rewind, fast forward, slow motion playback, and the like. For example, during a pause, the client 104 may continue to record the content 118(n) in the storage device 120 as content 122(c). The client 104, through execution of the client communication module 124, may then playback the content 122(c) from the storage device 120, starting at the point in time the content 122(c) was paused, while continuing to record the currently-broadcast content 118(n) in the storage device 120 from the network operator 102.

When playback of the content 122(c) is requested, the client communication module 124 retrieves the content 122(c). The client communication module 124 may also restore the content 122(c) to the original encoded format as received from the content provider 108. For example, when the content 122(c) is recorded on the storage device 120, the content 122(c) may be compressed. Therefore, when the client communication module 124 retrieves the content 122(c), the content 122(c) is decompressed for rendering by the display device.

Thus, in the environment 100 of FIG. 1, the content provider 108 may broadcast the content 116(k) over a network connection 110 to a multiplicity of network operators, an example of which is illustrated as network operator 102. The network operator 102 may then stream the content 118(n) over a network connection 112 to a multitude of clients, an example of which is illustrated as client 104. The client 104 may then store the content 118(n) in the storage device 120 as content 122(c), such as when the client 104 is configured to include digital video recorder (DVR) functionality, and/or output the content 118(n) directly.

The remote control device 106 is illustrated as including a control module 126 that is representative of functionality to control operation of the remote control device 106 as well as the client 104. The control module 126, for instance, is illustrated as including a control function initiation module 128 that is representative of functionality to initiate control functions of the client 104. For example, the control function initiation module 128 may be configured to receive inputs related to selection of representations of control functions, such as a selection of a “volume up” representation on the remote control device 106 using a button or other control functions (e.g., time-shifting functions) as previously described. Data representing this selection may then be communicated via network connection 114 to the client 104 that causes the client 104 (e.g., the client communication module 124) to increase the volume. A variety of other control functions may also be initiated by the control function initiation module 128 as previously described.

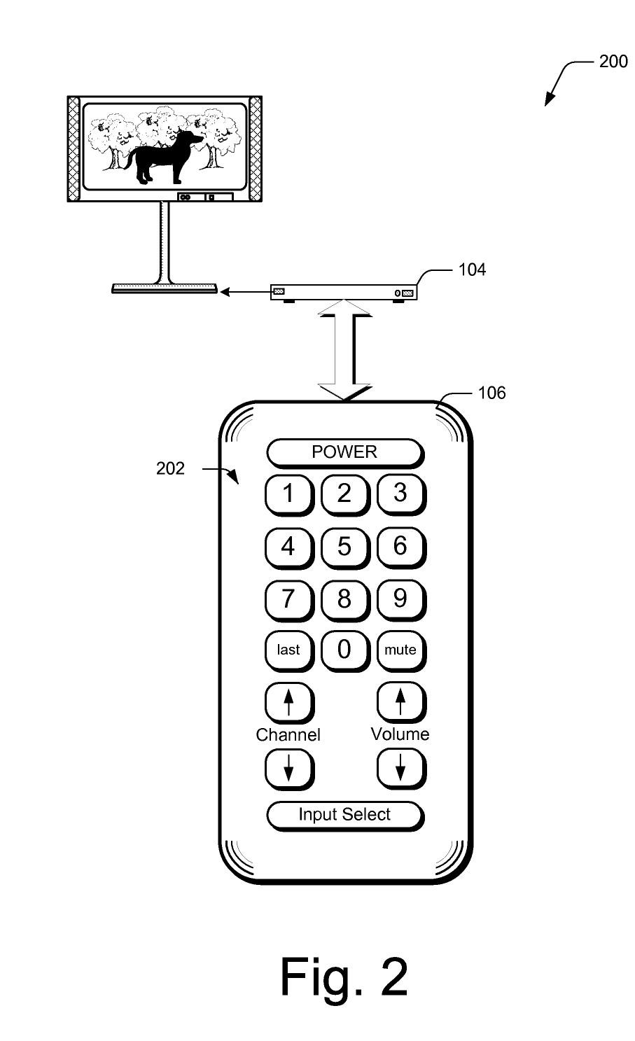

FIG. 2 depicts an example system 200 showing the remote control device 106 in greater detail as displaying representations 202 of one or more control functions of the client 104 that may be initiated through selection on the remote control device 106. The illustrated remote control device 106 includes a display device (e.g., a touch screen) that consumes approximately half of an outer surface of the remote control device thereby giving the remote control device an appearance of a “glassy brick”.

In another implementation, the display device of the remote control device 104 covers at least forty percent of the outer surface of the remote control device 104. In a further implementation, the display device consumes, approximately, an outer surface of the remote control device 106 that is viewable by a user when placed on a surface (e.g., a top of a table) and/or grasped in a hand of the user, e.g., the illustrated outer surface of the remote control device 106 in FIG. 2. A variety of other implementations are also contemplated, such as implementations in which the display device of the remote control device 106 includes more or less than the previously described amounts of the outer surface of the remote control device 106.

A user may supply an input to initiate the represented control function by the client 104 by selecting one or more of the representations 202 using a touch screen or other input device,. As illustrated by the remote control device 106 of FIG. 2, for instance, a user may select a “power” representation, one or more numbers to select a particular channel, “mute”, “last”, “channel up”, “channel down”, “volume up”, “volume down” and “input select”. Thus, the remote control device 106 may communicate with the client 104 to control output of content by the client 104 and thus may be referred to as being utilized in a “control function” mode.

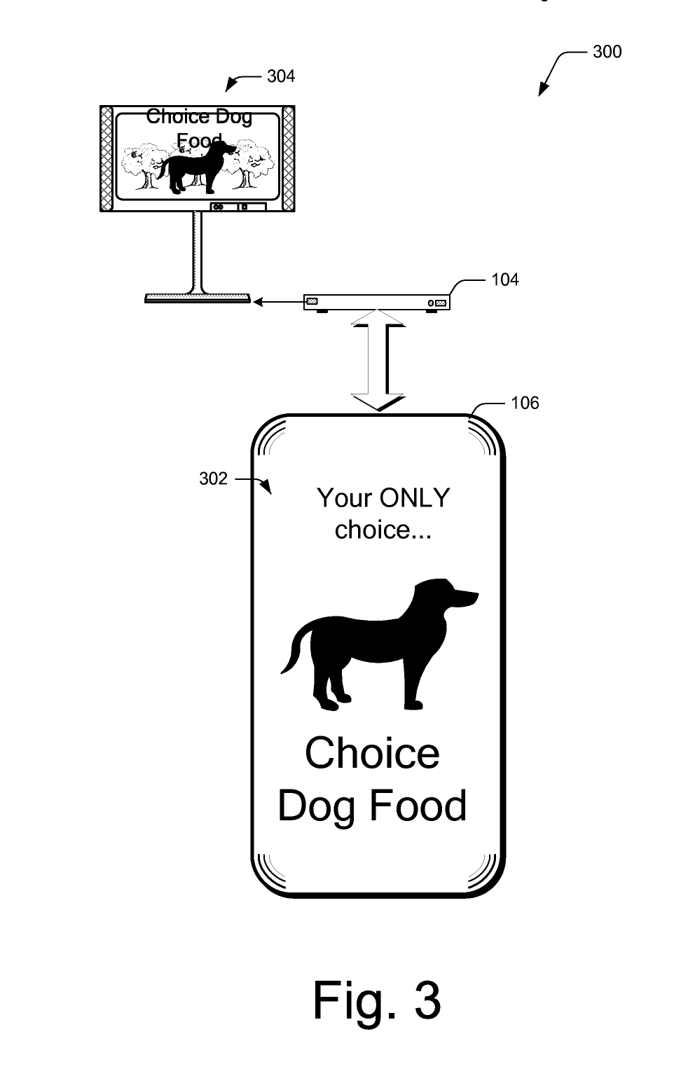

FIG. 3 depicts an example system 300 showing the remote control device 106 of FIG. 2 as displaying an advertisement 302. The advertisement 302 of FIG. 3 that is displayed by the remote control device 106 consumes an approximate available display area of the display device of the remote control device 106, although other implementations are also contemplated.

In the illustrated system 300, the remote control device 106 is in an “advertisement mode” such that the advertisement 302 replaces at least one of the representations 202 of the control functions of the control function mode of FIG. 2. This replacement may be performed in response to a wide variety of conditions, such as in response to an input provided by a user and/or the client 104, and so on. Further, although replacement of the representations 202 with the advertisement 302 has been described, a variety of other implementations are also contemplated, such as through simultaneous display in dedicated areas of the display device of the remote control device 106 of the representations 202 and the advertisement 302, respectively.

The advertisement 302 may be provided to the remote control device for output in a variety of ways. Returning now to FIG. 1, for instance, the network operator 102 is illustrated as including an ad module 130 that is representative of functionality to provide a service to stream advertisements to be displayed on the client 104 and/or advertisements to be displayed on the remote control device 106.

The service, for instance, may be accessible via an ad interface 132 over a network connection 134 by an advertiser 136, which as before may be representative of one or more advertisers that access the ad interface 132 over a network. The advertiser 136, for instance, may interact with the ad interface 132 to determine which opportunities are available to include one or more advertisements 138(a) (where “a” may be an integer from one to “A”) and/or how the opportunities are available, e.g., for a particular price, by auction, per confirmed viewing, and so on. The advertiser 136, for instance, may specify and/or accept an offer to pay a particular amount each time viewing of one or more of the advertisements 138(a) is confirmed.

For example, a display of an advertisement on the remote control device 106 may be coordinated with an output of content by the client 104 that is also an advertisement. The advertisement 302 of FIG. 3, for instance, may be a static image of a brand that corresponds to a brand of a product or service output in an advertisement 304 by the client 104. As illustrated in FIG. 3, the advertisement 302 for “Choice Dog Food” may be displayed on the remote control 106 when the client 104 outputs an advertisement 304 that is also for “Choice Dog Food”. Thus, in this instance the advertisement 302 is coordinated with an output of content by the client 104 that is also an advertisement 304. Alternatively, the advertisement may be unrelated to any advertisement being shown during the output of the content. This allows a secondary source of revenue to be generated from the remote control advertisements. These advertisements may last for any particular length of time, e.g., during a program, for 30 seconds, for an hour, for a day, tied to an event, and so on. The advertisement could also be a video version of an advertisement. The advertisement, for instance, could also be a static image that becomes a video upon selection. For example, the advertisement may be a logo for a movie, and selecting it starts the trailer. In a further embodiment, selection of the logo pauses the output of the content on the television, and the video plays on the main viewing screen. The advertisements may be trickled to the remote at any time to be stored at the remote for later display, which is especially useful as a technique if the advertisements are unrelated to the real time broadcast of the content.

The advertisement 302 displayed on the remote control device 106 may also be configured to confirm viewing of the advertisement on the client 104 and/or the advertisement on the remote control device 106. Returning now to FIG. 1, the remote control device 106, for instance, is illustrated as including an ad display module 140 that is representative of functionality to obtain and/or display the advertisement 138(a). For example, the advertisement 138(a) may be obtained by the ad display module 140 directly from the advertiser 136 and/or indirectly through the client 104. The ad display module 140 may then render the advertisement 138(a) for display, such as a static image, as video, audio and so on.

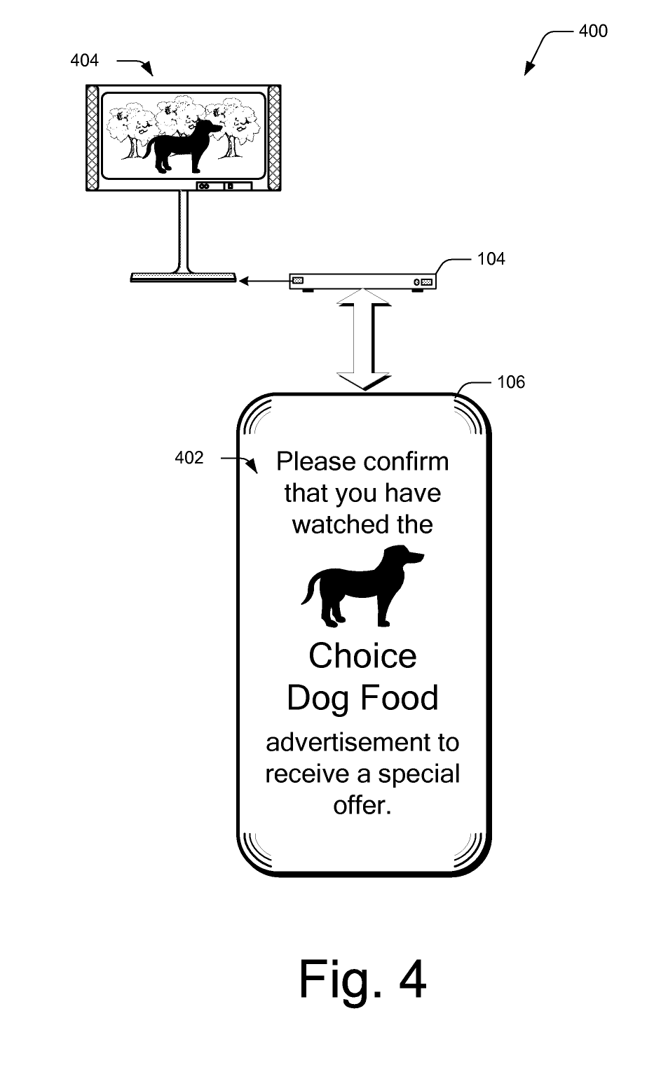

The ad display module 140 is also illustrated in including a confirmation module 142 that is representative of functionality of the remote control device 106 to confirm viewing of a display of the advertisement 138(a), either by the client 104 and/or the remote control device 106. Referring now to FIG. 4, for instance, a system 400 is illustrated in which the remote control device 106 displays an advertisement 402 that is configured to confirm viewing of the advertisement 404 output by the client 104 and which also may be used to confirm viewing of the advertisement 402 itself on the remote control device 106.

The advertisement 402 displayed on the remote control device 106 includes text which includes “Please confirm that you have watched the Choice Dog Food advertisement to receive a special offer”. Selection of the advertisement 402 (e.g., by pressing a dog icon on a touch screen) may be used to confirm that the user has viewed the advertisement 404 output by the client. Additionally, the text and other data (e.g., the icon of the dog) output by the remote control device 106 itself may also serve as an advertisement on the remote control device 106. Therefore, selection of the advertisement 402 on the remote control device 106 may also confirm that the user has viewed the advertisement 402. Thus, in this example the advertisement 402 includes a query that is to be viewed by the user which request that the user confirm that the advertisement 404 output by the client has been viewed. In an implementation, a “filter” question may be used to further confirm that the user has viewing the advertisement, such as a question that relates to the substance of the advertisement. The advertisement output by the remote control device 106 may also provide an incentive for a user to confirm viewing out of the advertisement, an example which is shown in the following figure.

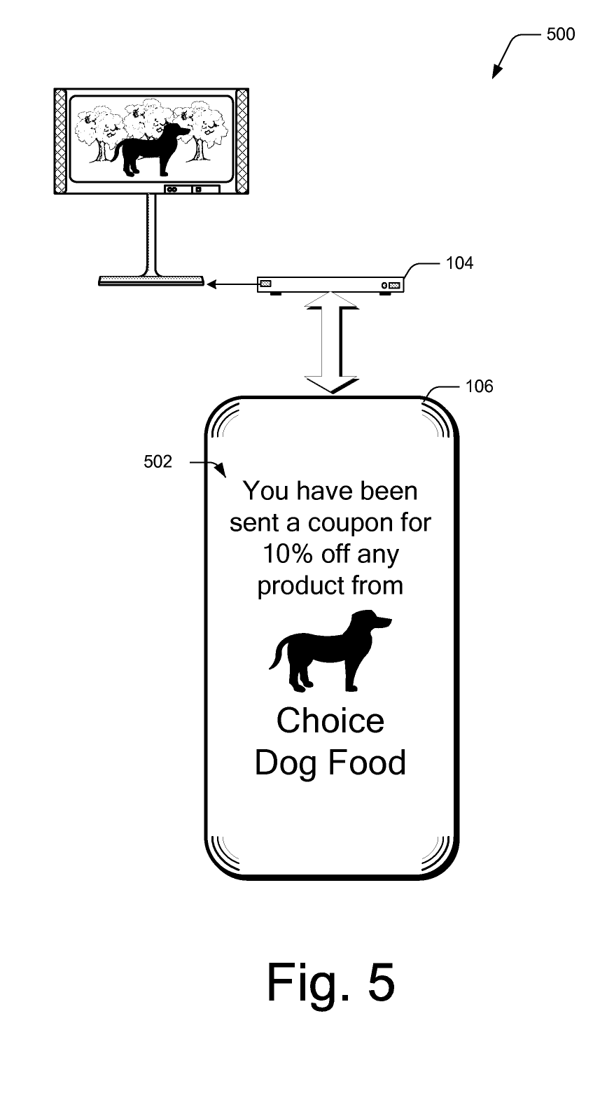

FIG. 5 depicts an example system 500 in which the advertisement 502 output on the remote control device 106 includes an incentive. The incentive in the example system 500 is illustrated as a coupon. However, a variety of other incentives are also contemplated, such as monetary enticements and so on.

The incentive included in the advertisement 502 may be redeemed in a variety of ways. When the advertisement 502 is configured as a coupon, for instance, data may be sent to the user that is usable to redeem the coupon, such as a validation code. For example, the remote control device 106 may be configured to include wireless phone functionality. Therefore the incentive may be stored locally on the remote control device 106 (e.g., as an email, SMS message, and so forth) to be retrieved locally (e.g., over a local wireless connection) by an entity that applies the incentive, such as a traditional bricks and mortar store. Thus, in this example the remote control is also the user's phone, such that the user can take the phone to the store and have the coupon retrieved by the store and the discount applied. A variety of other examples are also contemplated.

Returning back to FIG. 1, the advertiser 136 may provide a variety of advertisements 138(a) in a variety of configurations, such as configured for output by the client 104 as a client advertisement 144 or configured for output by the remote control device 106 as a remote control advertisement 146. Thus, the advertisements 138(a) may be configured specifically for the respective devices. For example, the advertiser 136 may configure the client advertisement 144 for output by the client 104 and a remote control advertisement 146 for output by the remote control device 106. The remote control advertisement 146 may be provided in a separate data stream that is sent with a broadcast that contains “remote control size” advertisements and thus may be distributed to the remote control device 106 in connection with the content 118(n) being broadcast by the network operator 102, which may also include advertisements (e.g., client advertisement 144) for display on the client 104. In an implementation, the advertisements 138(a) may also be targeted to address functionality of the respective devices, e.g., resolution, static vs. moving, color palettes, input functionality (e.g., touch screen versus buttons) and so on.

Generally, any of the functions described herein can be implemented using software, firmware, hardware (e.g., fixed-logic circuitry), manual processing, or a combination of these implementations. The terms “module”, “functionality” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable memory devices. The features of the techniques described herein are platform-independent, meaning that the techniques may be implemented on a variety of commercial computing platforms having a variety of processors.

Example Procedures

The following discussion describes techniques that may be implemented utilizing the previously described environment, systems, user interfaces and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the systems 200-500 of FIGS. 2-5, respectively.

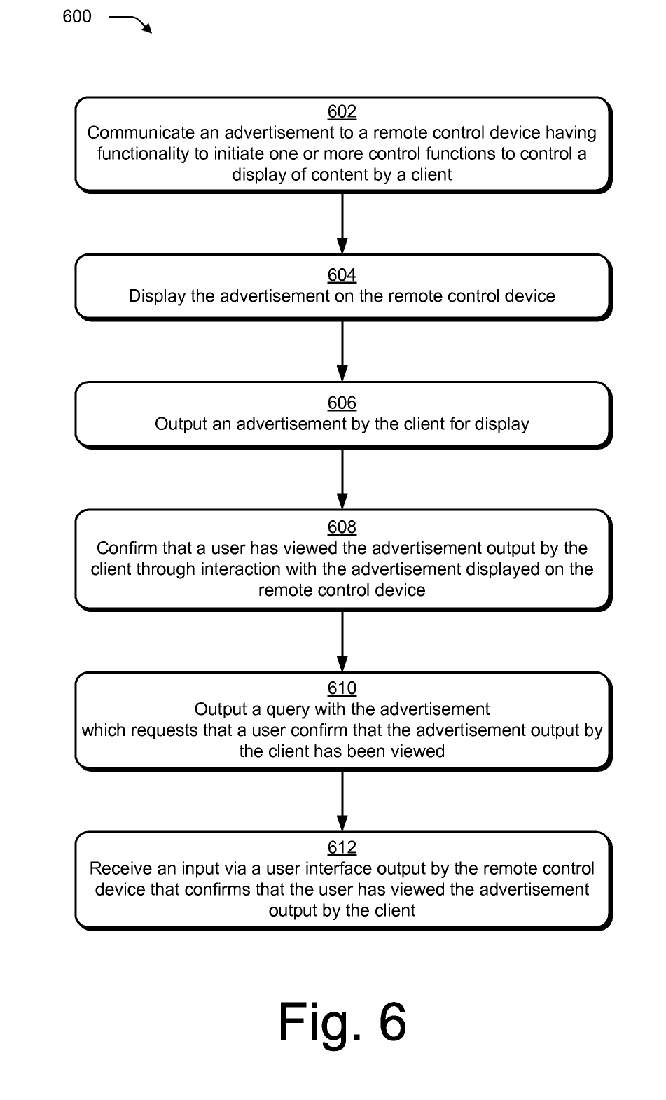

FIG. 6 depicts a procedure 600 in an example implementation in which viewing of an advertisement is confirmed. An advertisement is communicated to a remote control device having functionality to initiate one or more control functions to control a display of content by client (block 602). For example, the remote control advertisement 146 may be communicated to the remote control device 106 via the client 104, directly from the network operator 102 without passing through the client 104, and so on. Additionally, the advertisement may be chosen in a variety of ways, such as based on a user profile (e.g., through identification of the user or user type, a profile that was automatically created based on monitored interaction of the user with content, and so on), content output by the client (e.g., concurrently and/or on another channel), and so forth.

The advertisement is displayed on the remote control device (block 604). Advertisement 138(a), for instance, may be specifically configured as a remote control advertisement 146 for output on the remote control device 106, such as to address the particular functionality (e.g., display resolution, support for motion versus static images, and so on) of the remote control device 106. In another instance the advertiser 138(a) may be processed by the ad display module 140 for output by the remote control device 106.

For example, the advertisement 138(a) may be initially configured as a client advertisement 144 for output by the client 104. The ad display module 140 may reconfigure the advertisement 138(a) to be suitable for output by the remote control device 106. Thus, in this example separate advertisements are not specifically configured for output by the remote control device 106. Rather, the remote control device 106 may dynamically reconfigure advertisements originally intended for the client 104.

Likewise, the client 104 outputs an advertisement for display (block 606). For example, the advertisement 138(a) may be streamed with content 118(n) to the client 104, such as a television commercial included within a television program.

A confirmation is made that a user has viewed an advertisement output by the client through interaction with the advertisement displayed on the remote control device (block 608). As shown in FIG. 4, for instance, the advertisement 402 output by the remote control device 106 includes a query which requests that the user confirm that the advertisement 404 output by the client 104 has been viewed (block 610).

An input may then be received via a user interface for output by the remote control device 106 that confirms that the user has viewed the advertisement 404 output by the client 104 (block 612), such as by interacting with a touchscreen of the remote control device 106. A variety of other instances are also contemplated. Confirmation of advertisement viewing may also be utilized to support a variety of business models, an example of which may be found in relation to the following figure.

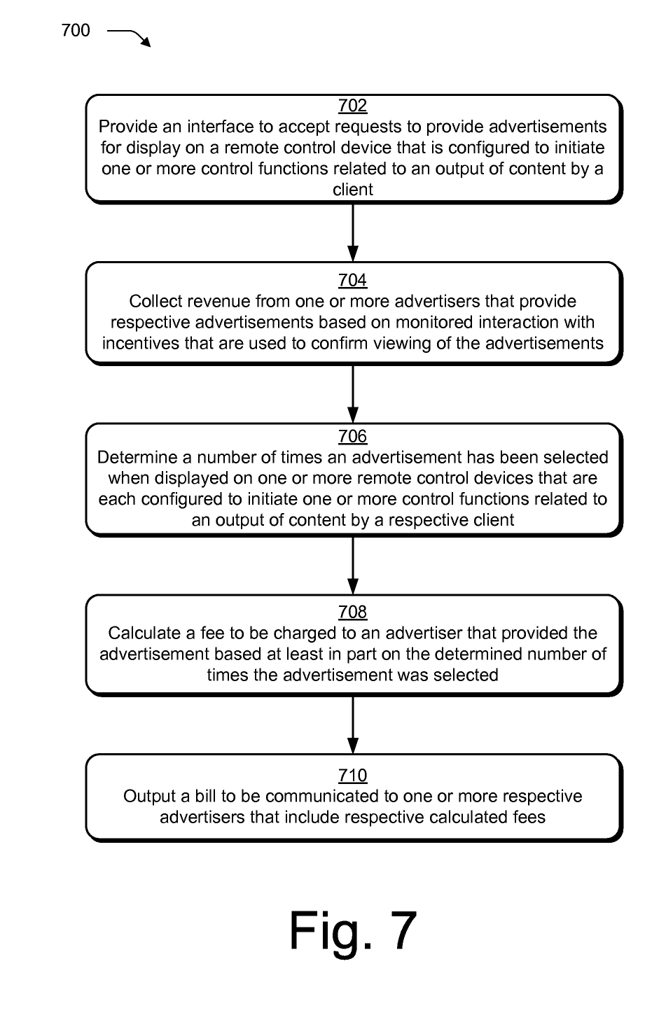

FIG. 7 depicts a procedure 700 in an example implementation in which a business model is supported through confirmation of advertisement viewing. An interface is provided to accept requests to provide advertisements for display on a remote control device that is configured to initiate one or more control functions related to an output of content by a client (block 702). For example, the network operator 102 may output ad interface 132 to be accessible to the advertiser 136 over a network connection 134. The request may be formatted in a variety of ways. For example, the requests may be configured as bids that are part of an auction, as a response to opportunities to advertise during one or more ad avails, and so on. For instance, the request may pertain to a particular geographic location that is to receive a respective advertisement, such as for a particular zip code. Accordingly, the ad interface 132 may provide a variety of data to assist the advertiser 136 in making a decision, such as to identify the content, broadcast time, type (VOD vs. broadcast), and so on.

Revenue is collected from one or more advertisers to provide respective advertisements based on monitored interaction with incentives that are used to confirm viewing of the advertisements (block 704). The revenue may be collected in a variety of ways that pertain to how the advertising opportunity was offered, such as auction, offer for sale, and so on.

For example, a determination may be made as to a number of times the advertisement has been selected and displayed on one or more remote control devices that are each configured to initiate one or more control functions related to an output of content by a respective client (block 706). For example the determination may be based on a number of times an incentive was requested that confirms that the advertisement was viewed, such as to request the coupon shown in FIG. 5 via the advertisement 402 shown in FIG. 4.

A fee may then be calculated that is to be charged to an advertiser that provided the advertisement based at least in part on the determined number of times the advertisement was selected (block 708). In an implementation, this fee may be calculated using techniques that are similar to “click through” and “impression” fees. For example, a monetary amount may be assigned for each time the advertisement is selected and/or displayed on the remote control device 106.

A bill may then be output for communication to one or more respective advertisers that include respective calculated fees (block 710). For example, the bill may be emailed by the network operator 102 to the advertiser 136, may be sent via traditional mail, and so on.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
displaying an advertisement on a remote control device having functionality to initiate one or more control functions to control a display of content by a client; and
confirming that a user has viewed an advertisement output by the client through interaction with the advertisement displayed on the remote control device.

2. A method as described in claim 1, wherein the display of the advertisement on the remote control device is performed concurrently with the output of the advertisement by the client.

3. A method as described in claim 1, wherein the advertisement output by the client corresponds to the advertisement displayed on the remote control device.

4. A method as described in claim 1, wherein the advertisement displayed on the remote control device is a static image.

5. A method as described in claim 1, wherein the displaying of the advertisement on the remote control is performed such that the display of the advertisement replaces a display of a representation of at least one said control function on the remote control device.

6. A method as described in claim 1, wherein the advertisement output by the remote control device includes a query, to be viewed by the user, which requests that the user confirm that the advertisement output by the client has been viewed.

7. A method as described in claim 6, wherein the confirming further includes receiving an input via a user interface output by the remote control device that confirms that the user has viewed the advertisement output by the client.

8. A method as described in claim 1, wherein the confirming includes providing an incentive to the user to perform the confirming.

9. A method as described in claim 8, wherein the incentive:
is stored locally on the remote control device; and
is retrievable locally by an entity that applies the incentive.

10. A method as described in claim 8, wherein the incentive is a coupon that is related to a product or service that is a subject of the advertisement output by the client and the advertisement output by the remote control device.

11. A method as described in claim 8, wherein the incentive:
is communicated using the simple message service (SMS); and
includes a validation code that is verifiable by a provider of the incentive.

12. A method comprising:
providing a service to display advertisements on a remote control device that is configured to initiate one or more control functions related to output of content by a client; and
collecting revenue from one or more advertisers that provide respective said advertisements based on monitored interaction with the advertisements.

13. A method as described in claim 12, wherein the service is a web service that includes an interface that is accessible by the one or more advertisers via a network.

14. A method as described in claim 12, wherein the advertisements are to be displayed on the remote control device concurrently with an output of a corresponding advertisement by the client.

15. A method as described in claim 12, wherein at least one said advertisement to be displayed on the remote control device is a static image for a brand that corresponds to an advertisement that is concurrently output by the client.

16. A method as described in claim 12, wherein the service is accessible over a network to provide opportunities to the one or more advertisers to provide respective said bids for specific points in time in relation to an output of the content by the client.

17. A method as described in claim 16, wherein at least one said bid pertains to a particular geographic location that is to receive a respective said advertisement.

18. One or more computer-readable media comprising instructions that are executable to:
determine a number of times an advertisement has been selected when displayed on one or more remote control devices that are each configured to initiate one or more control functions related to an output of content by a respective client; and
calculate a fee to be charged to an advertiser that provided the advertisement based at least in part on the determined number of times the advertisement was selected.

19. One or more computer-readable media as described in claim 18, wherein the determination of the number of times is based at least in part on a number of times an incentive was requested that confirms that the advertisement was viewed.

20. One or more computer-readable media as described in claim 18, wherein the fee is calculated at least in part on a number of times the advertisement was displayed.
